(19) United States
(12) Patent Application Publication
(10) Pub. No.: US 2011/0112713 A1
(43) Pub. Date: May 12, 2011

(54) CONTROL METHOD AND CLEANING ROBOT UTILIZING THE SAME

(76) Inventors: You-Wei Teng, Taipei County (TW); Hong Lun Liu, Hualien County (TW); Yi-Chih Yeh, Taipei County (TW)

(21) Appl. No.: 12/730,728

(22) Filed: Mar. 24, 2010

(30) Foreign Application Priority Data
Nov. 10, 2009 (TW) 98138023

(51) Int. Cl. G05D 1/00

(52) U.S. Cl. 701/25

(57) ABSTRACT

A control method for a cleaning robot's movement in a closed space is disclosed. The cleaning robot is activated to search a boundary of the closed space. The cleaning robot is activated to move along the boundary. When the cleaning robot moves along the boundary, the movement route of the cleaning robot is referred to as a first movement route. The first movement route is recorded. The cleaning robot is activated to move along a second movement route according to the recording result. The second movement route does not overlap the first movement route.

### CROSS REFERENCE TO RELATED APPLICATIONS

This Application claims priority of Taiwan Patent Application No. 098138023, filed on Nov. 10, 2009, the entirety of which is incorporated by reference herein.

### BACKGROUND OF THE INVENTION

1. Field of the Invention

The invention relates to a control method, and more particularly to a control method for a cleaning robot.

2. Description of the Related Art

With technology development, functions and types of electronic products have increased. With the development of cleaning robots, cleaning time has been reduced. In order to operate effectively, cleaning robots are programmed with a movement function and a navigation function, the cleaning robot is capable of functioning autonomously in its work area. However, the movement patterns of the cleaning robot are random. Thus, cleaning work is often very inefficient and cannot be finished effectively.

### BRIEF SUMMARY OF THE INVENTION

A control method for a cleaning robot movement in an enclosed space is provided. An exemplary embodiment of a control method for a cleaning robot is described in the following paragraphs. The cleaning robot is activated to search a boundary of the closed space. The cleaning robot is activated to move along the boundary. When the cleaning robot moves along the boundary, the movement route of the cleaning robot is referred to as a first movement route. The first movement route is recorded. The cleaning robot is activated to move along a second movement route according to the recording result. The second movement route does not overlap the first movement route.

A description of cleaning robots which are used to clean an enclosed space is also provided. An exemplary embodiment of a cleaning robot comprises at least one roller, a detection unit and a control unit. The control unit activates the roller according to a detected result of the detection unit. The control unit activates the roller to roll such that the detection unit detects a boundary of the closed space. The control unit activates the roller to roll along the boundary. When the roller rolls along the boundary, the movement route of the roller is referred to as a first movement route. The control unit records the first movement route and activates the roller to move along a second movement route according to the recording result. The second movement route does not overlap the first movement route.

A detailed description is given in the following embodiments with reference to the accompanying drawings.

### BRIEF DESCRIPTION OF THE DRAWINGS

The invention can be more fully understood by referring to the following detailed description and examples with references made to the accompanying drawings, wherein:

FIG. 1 is a flowchart of an exemplary embodiment of a control method of the invention;

FIG. 2A is a schematic diagram of an exemplary embodiment of the closed space boundary determination function;

FIGS. 2B-2D are schematic diagrams of other exemplary embodiments of the closed space boundary determination function;

FIG. 3A is a schematic diagram of an exemplary embodiment which displays the movement route of the cleaning robot;

FIG. 3B is a schematic diagram of another exemplary embodiment the movement route of the cleaning robot;

FIG. 4 is a schematic diagram of an exemplary embodiment of the movement route of the cleaning robot of the invention;

FIGS. 5A and 5B are schematic diagrams of other exemplary embodiments of the movement routes of the cleaning robot of the invention; and

FIG. 6 is a schematic diagram of an exemplary embodiment of a cleaning robot of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

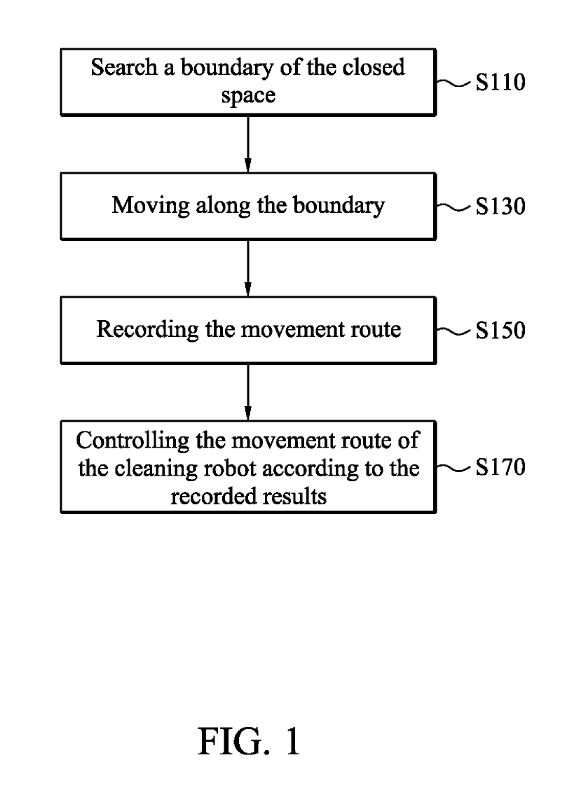

FIG. 1 is a flowchart of an exemplary embodiment of a control method of the invention. The control method is applied to control a cleaning robot such that the cleaning robot moves in a closed space. The cleaning robot passes through various routes. The routes are cleaned by the cleaning robot.

The cleaning robot is activated to move and search a boundary of the closed space (step S110). The invention does not limit the method of searching the boundary. In other embodiments, the cleaning robot can utilize different methods to search the boundary of the closed space.

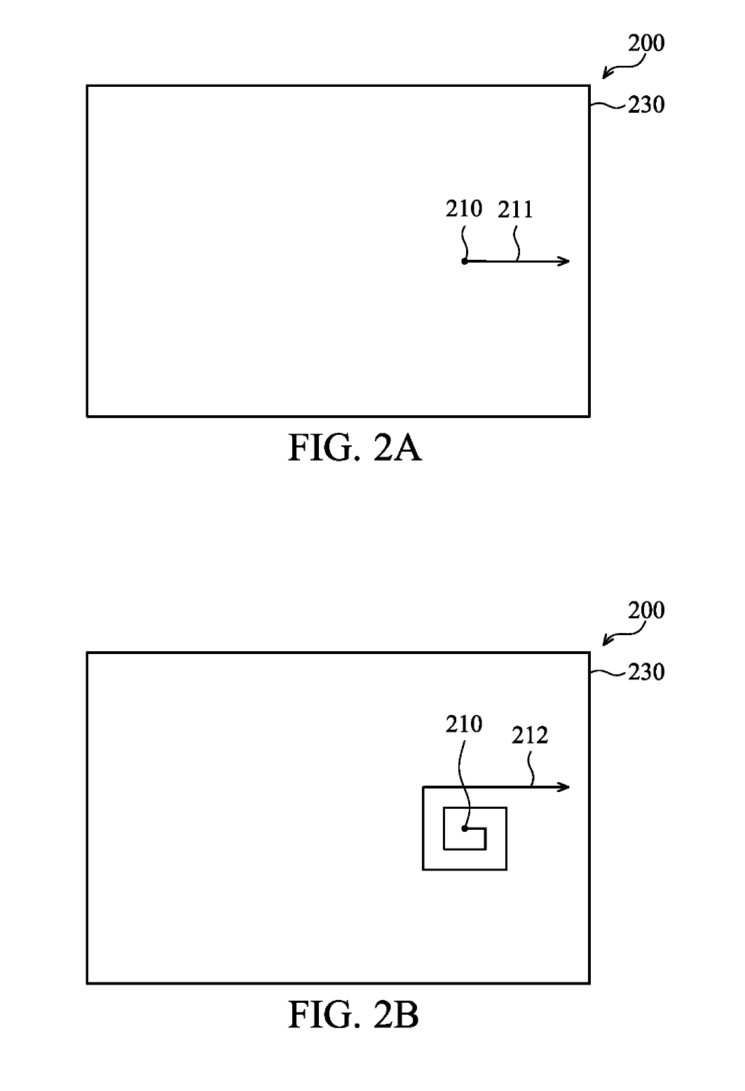

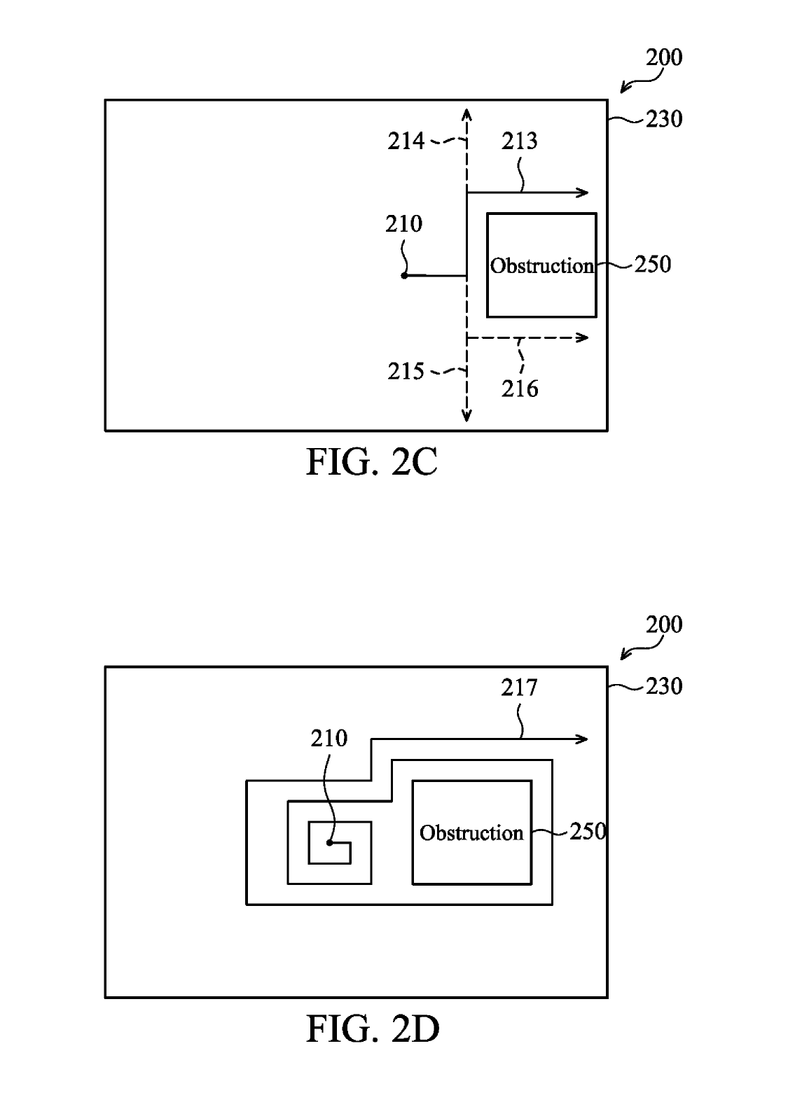

FIG. 2A is a schematic diagram of an exemplary embodiment of the closed space boundary determination function. As shown in FIG. 2A, the cleaning robot moves in a straight line as it attempts to search the boundary. The cleaning robot moves from a beginning point 210. The cleaning robot moves and searches a boundary 230 of the closed space 200, wherein the movement route of the cleaning robot is a straight line as is searches for the boundary. When the cleaning robot searches the boundary 230, the movement route of the cleaning robot is referred to as a searching route 211.

FIG. 2B is a schematic diagram of another exemplary embodiment of the closed space boundary determination function. As shown in FIG. 2B, the shape of the movement rout of the cleaning robot, when searching the boundary 230, is a helical shape. The cleaning robot used the beginning point 210 as a center point. The cleaning robot uses the helical shape as a frame of reference as it searches for the boundary. When the cleaning robot searches the boundary 230, the movement route of the cleaning robot is referred to as a searching route 212. In this embodiment, the shape of the searching route 212 is a square helical shape.

Additionally, when the cleaning robot is searching for the boundary, if the cleaning robot encounters an obstruction, the cleaning robot detours around the obstruction to continuously search for the boundary. FIG. 2C is a schematic diagram of another exemplary embodiment of the closed space boundary determination function. The cleaning robot moves from the beginning point 210. The movement route of the cleaning robot, movement from the beginning point 210, is a straight line. When the cleaning robot meets an obstruction 250, the cleaning robot detours around the obstruction 250 to continuously search for the boundary 230. After detouring around the obstruction 250, the movement route of the cleaning robot becomes straight.

The invention does not limit the way in which the cleaning robot can detour around obstructions 250. In one embodiment, when the cleaning robot meets an obstruction 250, the cleaning robot moves along one of the routes 213-216 to search the boundary 230.

FIG. 2D is a schematic diagram of another exemplary embodiment of the closed space boundary determination function. The cleaning robot starts to move from the beginning point 210, wherein the movement route of the cleaning robot is helical. When the cleaning robot meets an obstruction 250, the cleaning robot surrounds the obstruction 250. After surrounding the obstruction 250, the movement route of the cleaning robot is straight until it searches the boundary 230.

In this embodiment, when the cleaning robot meets an obstruction 250, the cleaning robot continuously moves according to a helical shape. Thus, the route 217, used to determine the boundary 230, will surround the obstruction 250. In other embodiments, when the cleaning robot meets the obstruction 250, the shape of the movement route of the cleaning robot changes from the helical shape to a straight shape or other shapes.

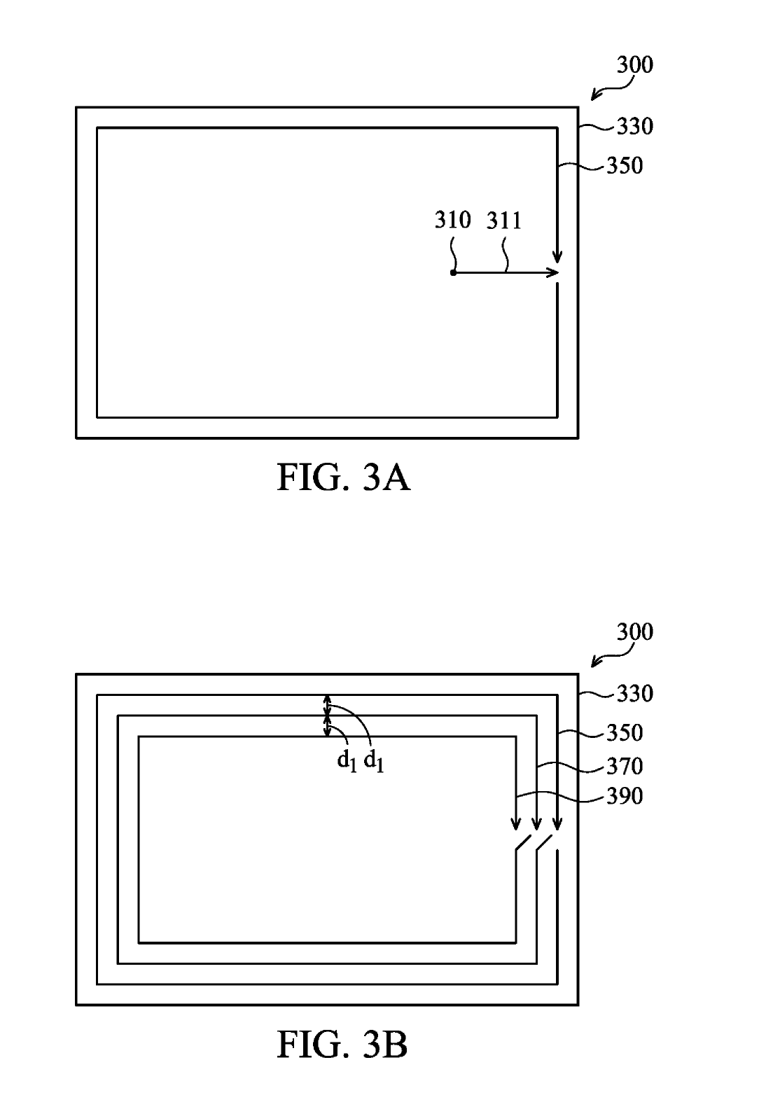

After the closed space boundary determination function, the cleaning robot moves along the boundary (step S130). In this embodiment, when the cleaning robot moves along the boundary, the movement route of the cleaning robot is referred to as a first movement route. FIG. 3A is a schematic diagram of an exemplary embodiment of movement routes of the cleaning robot. In this embodiment, the cleaning robot starts to move from a beginning point 310, wherein the movement route of the cleaning robot is straight and is referred to as a searching route 311. After searching the boundary 330, the cleaning robot moves along the boundary 330. When the cleaning robot moves along the boundary 330, the movement route of the cleaning robot is shown as the movement route 350 in FIG. 3A.

The movement route is recorded (step S150). Taking FIG. 3A as an example, the searching route 311 and the movement route 350 are recorded. In another embodiment, the movement route 350 is only recorded. When the movement routes of the cleaning robot are recorded, non-cleaning region can be defined to increase the cleaning efficiency of the cleaning robot.

The recorded results are utilized to control the movement route of the cleaning robot (step S170). In this embodiment, when the recorded result is utilized to control the movement route of the cleaning robot, the movement route of the cleaning robot is referred to as a second movement route. The second movement route does not overlap with the first movement route. Thus, the cleaning work of the cleaning robot can be accomplished effectively and the coverage rate of the cleaning work reaches 100%.

Taking FIG. 3B as an example, when the cleaning robot moves along the boundary 330, the movement route 350 can be obtained. The cleaning robot uses the movement route 350 as a virtual boundary and moves along the virtual boundary. When the cleaning robot moves along the virtual boundary, the movement route of the cleaning robot is shown as movement route 370 in FIG. 3B. In this embodiment, the movement route 350 does not overlap the movement route 370.

In another embodiment, the cleaning robot serves the movement route 370 as a new virtual boundary. The cleaning robot moves along the new virtual boundary (i.e. the movement route 370). When the cleaning robot moves along the new virtual boundary, the movement route of the cleaning robot is shown as a movement route 390 in FIG. 3B. Thus, the cleaning robot effectively finishes a cleaning work.

In this embodiment, a specific relationship occurs among the movement routes 350, 370, and 390. For example, the shapes of the movement routes 350, 370, and 390 are similar. The length of the movement route 350 is longer than the length of the movement route 370. The length of the movement route 370 is longer than the length of the movement route 390. Further, the distance between the movement routes 350 and 370 maintains a fixed value d₁. The distance between the movement routes 370 and 390 also maintains in the fixed value d₁.

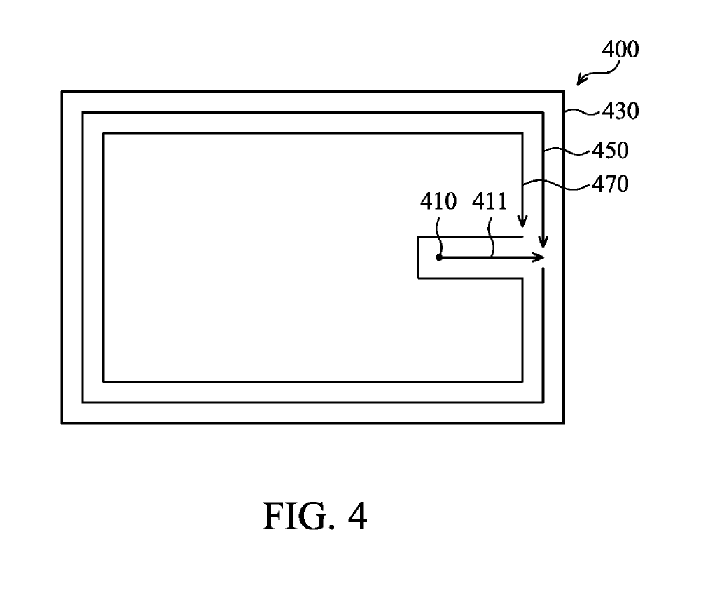

FIG. 4 is a schematic diagram of an exemplary embodiment of the movement route of the cleaning robot of the invention. In this embodiment, the movement routes are not overlapped with each other. As shown in FIG. 4, the cleaning robot starts movement from the beginning point 410 to search a boundary 430 of a closed space 400. The beginning point 410 is served as a center point and reference when movement is initiated. The shape of the movement route of the cleaning robot is a straight shape. The route of searching the boundary 430 is shown as a searching route 411 in FIG. 4.

After locating the boundary 430, the cleaning robot moves along the boundary 430. When the cleaning robot moves along the boundary 430, the movement route of the cleaning robot is shown as movement route 450 in FIG. 4. The cleaning robot uses the movement route 450 as a virtual boundary. The cleaning robot moves along the virtual boundary (i.e. the movement route 450).

When the cleaning robot moves along the virtual boundary, the movement route of the cleaning robot is shown as a movement route 470 in FIG. 4. The movement route 470 corresponds to the second movement route as claimed. In this embodiment, the movement route 470 does not overlap the searching route 411. Additionally, the length of the movement route 470 may be longer than the length of the movement route 450.

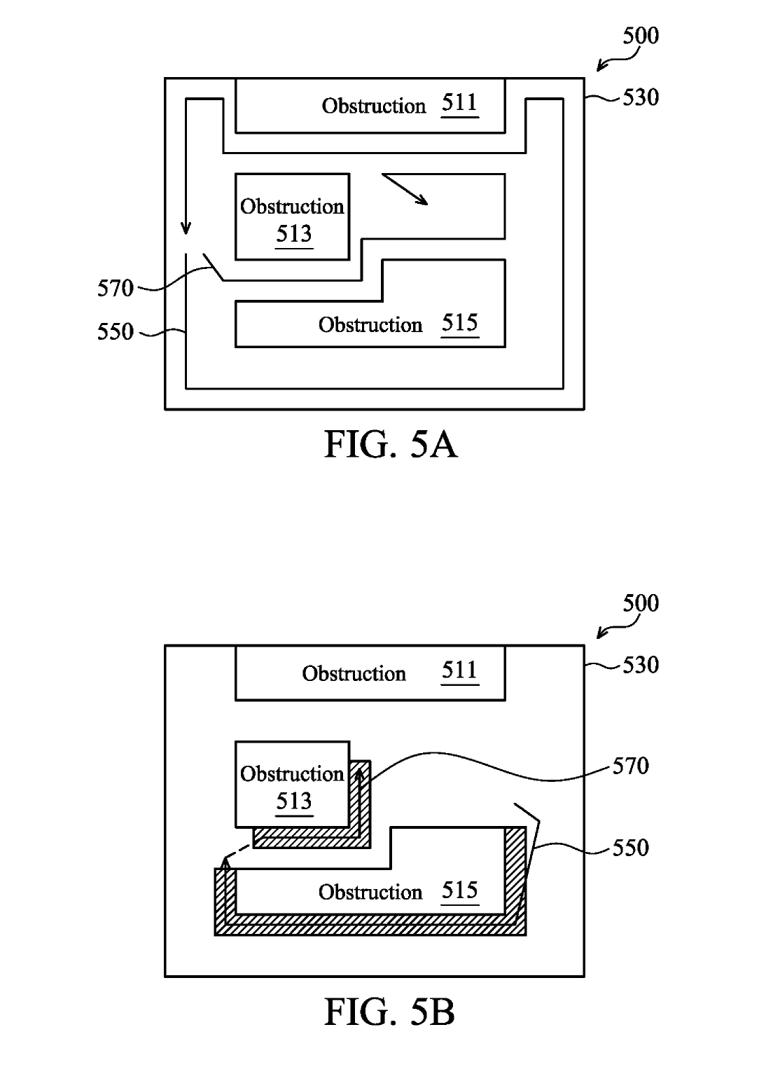

FIGS. 5A and 5B are schematic diagrams of other exemplary embodiments of the movement routes of the cleaning robot of the invention. The complexity of the closed space 500 is high. The closed space 500 comprises obstructions 511, 513, and 515. When the cleaning robot moves along the boundary 530, the movement route of the cleaning robot is shown as the movement route 550 in FIG. 5A. When the cleaning robot moves along the movement route 550, the movement route of the cleaning robot is shown as the movement route 570 in FIG. 5A. At this time, a portion of the closed space 500 is unclean. The un-cleaned regions are shown as oblique lines in FIG. 5B.

Since the cleaning robot records its movement routes, the cleaning robot aims to clean the un-cleaned regions shown as oblique lines in FIG. 5B. If an algorithm stored in the cleaning robot confirms that the un-cleaned regions are cleaned, the cleaning robot stops cleaning.

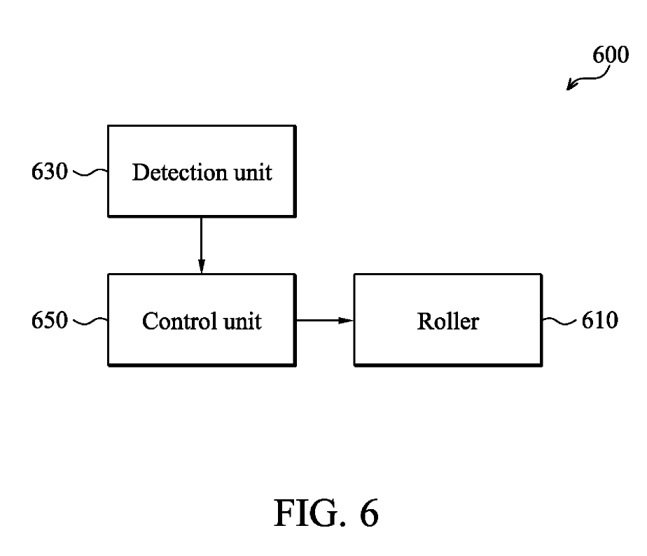

FIG. 6 is a schematic diagram of an exemplary embodiment of a cleaning robot of the invention. The cleaning robot 600 comprises at least a roller 610, a detection unit 630, and a control unit 650. The control unit 650 activates the roller 610 to roll such that the cleaning robot 600 moves. The control unit 650 controls the direction of roller 610 according to the detection results of the detection unit 630.

In this embodiment, the control unit 650 activates the roller 610 to roll and activates the detection unit 630 to detect boundary of a closed space. The invention does not limit the method by which it can detect boundaries. In one embodiment, the detection unit 630 emits a light wave or a sound wave. When the light wave or the sound wave hits a boundary, the boundary reflects the light wave or the sound wave. The detection unit 630 obtains the position of the boundary according to the reflected result.

The detection unit 630 activates the roller 610 according to the obtained result of the detection unit 630 such that the roller 610 moves to the boundary. In this embodiment, the movement route of the roller 610 is referred to as a searching route when the roller 610 moves to the boundary. The invention does not limit the shape of the searching route. In one embodiment, the shape of the searching route is straight, helical, or square helical.

When an obstruction is detected by the detection unit 630, the control unit 650 activates the roller 610 to detour around the obstruction such that the detection unit 630 continuously searches the boundary. When the roller 610 moves to the boundary, the control unit 650 activates the roller 610 to move along the boundary. In this embodiment, the movement route of the roller 610 is referred to as a first movement route when the roller 610 moves along the boundary.

The control unit 610 records the first movement route and controls the rolling direction of the roller 610 according to the recorded result. When the recorded result is utilized to control the rolling direction of the roller 610, the movement route of the roller 610 is referred to as a second movement route. In this embodiment, the first movement route does not overlap with the second movement route. In other embodiments, the first movement route, the second movement route, and the searching route do not overlap with each other. In this case, the length of the second movement route may be longer than the length of the first movement route because the second movement route detours around the searching route.

In another embodiment, the shape of the first movement route (e.g. the movement route 350 in FIG. 3B) is similar to the shape of the second movement route (e.g. the movement route 370 in FIG. 3B). In other embodiments, the length of the first movement route is longer than the length of the second movement route.

In this embodiment, the control unit 650 provides the first movement route with a first virtual boundary and controls the roller 610 as it rolls along the first virtual boundary. The movement route of the roller 610 is served as a second movement route.

In another embodiment, the control unit 350 records the second movement route and serves as the second movement route for a second virtual boundary. The control unit 650 activates the roller 610 to roll along the second virtual boundary. The movement route of the roller 610 serves as a third movement route.

In one embodiment, the length of the third movement route is shorter than the length of the second movement route. In other embodiments, the shape of the second movement route is similar to the shape of the third movement route. Further, the distance between the first and the second movement routes is equal to the distance between the second and the third movement routes.

Since the control unit 650 records the movement routes of the roller 610, the movement routes are not overlapped with each other. Thus, the cleaning work can be finished effectively.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A control method for a cleaning robot's movement in a closed space, comprising:
activating the cleaning robot to search a boundary of the closed space;
activating the cleaning robot to move along the boundary, wherein when the cleaning robot moves along the boundary, the movement route of the cleaning robot is referred to as a first movement route;
recording the first movement route; and
activating the cleaning robot to move along a second movement route according to the recorded result, wherein the second movement route does not overlap with the first movement route.

2. The control method as claimed in claim 1, wherein the shape of the first movement route is similar to the shape of the second movement route and the length of the first movement route is longer than the length of the second movement route.

3. The control method as claimed in claim 1, wherein the distance between the first and the second movement routes is fixed.

4. The control method as claimed in claim 1, further comprising:
serving the first movement route as a first virtual boundary; and
activating the cleaning robot to move along the first virtual boundary, wherein when the cleaning robot moves along the first virtual boundary, the movement route of the cleaning robot is served as the second movement route;
recording the second movement route;
serving the second movement route as a second virtual boundary; and
activating the cleaning robot to move along the second virtual boundary, wherein when the cleaning robot moves along the second virtual boundary, the movement route of the cleaning robot is served as a third movement route.

5. The control method as claimed in claim 4, wherein the length of the third movement route is shorter than the length of the second movement route.

6. The control method as claimed in claim 4, wherein the shape of the second movement route is similar to the shape of the third movement route.

7. The control method as claimed in claim 4, wherein the distance between the first and the second movement routes is fixed and the distance between the second and the third movement routes is the same as the distance between the first and the second movement routes.

8. The control method as claimed in claim 1, wherein when the boundary is found by the cleaning robot, the movement route of the cleaning robot serves as a searching route, the second movement route does not overlap the searching route and the length of the second movement route is longer than the length of the first movement route.

9. The control method as claimed in claim 1, wherein the cleaning robot utilizes a movement method to search the boundary; and
wherein the movement method comprises:
serving as a center point and reference when movement is initiated; and
moving out from the center point in a helical shaped pattern until the boundary is located, wherein the helical shape is a square shape.

10. The control method as claimed in claim 1, further comprising:
when the cleaning robot is searching for the boundary and the cleaning robot meets an obstruction, the cleaning robot detours around the obstruction to continue searching for the boundary.

11. A cleaning robot to clean a closed space, comprising:
at least one roller;
a detection unit; and
a control unit activating the direction of the roller according to a detection result of the detection unit, wherein:
the control unit activates the roller to roll such that the detection unit detects a boundary of the closed space;
the control unit activates the roller to roll along the boundary;
when the roller rolls along the boundary, the movement route of the roller is referred to as a first movement route;
the control unit records the first movement route and activates the roller to move along a second movement route according to the recorded result; and
the second movement route does not overlap with the first movement route.

12. The cleaning robot as claimed in claim 11, wherein the shape of the first movement route is similar to the shape of the second movement route and the length of the first movement route is longer than the length of the second movement route.

13. The cleaning robot as claimed in claim 11, wherein the distance between the first and the second movement routes is fixed.

14. The cleaning robot as claimed in claim 11, wherein the control unit serves the first movement route as a first virtual boundary and activates the roller to roll along the first virtual boundary, and wherein when the roller rolls along the first virtual boundary, the movement route of the roller is served as the second movement route;
wherein the control unit records the second movement route, serves the second movement route as a second virtual boundary, and activates the roller to roll along the second virtual boundary; and
wherein when the roller rolls along the second virtual boundary, the movement route of the roller is served as a third movement route.

15. The cleaning robot as claimed in claim 14, wherein the length of the third movement route is shorter than the length of the second movement route and the shape of the second movement route is similar to the shape of the third movement route.

16. The cleaning robot as claimed in claim 14, wherein the distance between the first and the second movement routes is fixed and the distance between the second and the third movement routes is the same as the distance between the first and the second movement routes.

17. The cleaning robot as claimed in claim 11, wherein when the boundary is found, the movement route of the roll serves as a searching route, and wherein the second movement route does not overlap the searching route, and the length of the second movement route is longer than the length of the first movement route.

18. The cleaning robot as claimed in claim 17, wherein the searching route is a straight line.

19. The cleaning robot as claimed in claim 17, wherein the shape of the searching route is a helical shape and the helical shape is a square shape.

20. The cleaning robot as claimed in claim 11, wherein when the detection unit detects an obstruction, and the control unit activates the roller to detour around the obstruction and activates the detection unit continuously search the boundary.
